(19) United States
(12) Patent Application Publication
(10) Pub. No.: US 2011/0304517 A1
(43) Pub. Date: Dec. 15, 2011

(54) HOUSING OF PORTABLE ELECTRONIC DEVICE AND METHOD FOR MAKING THE SAME

(75) Inventors: YONG-FA FAN, Shenzhen City (CN); YONG YAN, Shenzhen City (CN); ZHI-GUO ZHAO, Shenzhen City (CN); XUE-LI ZHANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/900,661

(22) Filed: Oct. 8, 2010

(30) Foreign Application Priority Data
Jun. 15, 2010 (CN) 201010200770.2

(51) Int. Cl. H01Q 1/42; B05D 5/12

(52) U.S. Cl. 343/872; 427/105

(57) ABSTRACT

A housing includes a first main body, a three-dimensional antenna, and a second main body. The three-dimensional antenna includes a printing layer attached to the first main body and a plating layer formed on the printing layer. The second main body is attached to the first main body and partially covering the three-dimensional antenna. The three-dimensional antenna is sandwiched between the first main body and the second main body, and the antenna is partially exposed from the first main body and the second main body to form a terminal.

This application is one of the two related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US33604 | HOUSING OF PORTABLE ELECTRONIC | Fan et al. |
| | DEVICE AND METHOD FOR MAKING | |
| | THE SAME | |
| US33605 | HOUSING OF PORTABLE ELECTRONIC | Fan et al. |
| | DEVICE AND METHOD FOR MAKING | |
| | THE SAME | |

### BACKGROUND

1. Technical Field

The present disclosure relates to housings of portable electronic devices, especially to a housing having a three-dimensional antenna formed thereon and a method for making the housing.

2. Description of Related Art

Antennas are critical for wireless communication of portable electronic devices (such as mobile phones, computers, PDAs, and so on). The antenna may be a thin metal radiator element mounted to a support member, and attached to a device's housing. However, the radiator element may be exposed from the housing, and easily damaged. In addition, the radiator element and the support member may occupy a large space. To solve this problem, a conductive ink may be printed on the housing to form the antenna by a screen printing method. However, this method is usually used to manufacture two-dimensional antennas.

Therefore, there is room for improvement within the art.

### BRIEF DESCRIPTION OF THE FIGURES

Many aspects of the housing of portable electronic device and method for making the housing can be better understood with reference to the following figures. The components in the figures are not necessarily drawn to scale, the emphasis instead being placed upon clearly illustrating the principles of the housing of portable electronic device and method for making the housing. Moreover, in the drawings like reference numerals designate corresponding parts throughout the several views.

FIG. 1 is a schematic view of an exemplary embodiment of a housing.

FIG. 2 is a partially exploded view of the exemplary embodiment of the housing shown in FIG. 1 including a three-dimensional antenna and a first main body.

FIG. 3 is a schematic view of the three-dimensional antenna formed on the first main body of FIG. 2.

FIG. 4 is a portion of a cross-sectional view of the housing taken along line IV-IV of FIG. 1.

FIG. 5 is a cross-sectional view of a first injection molding machine.

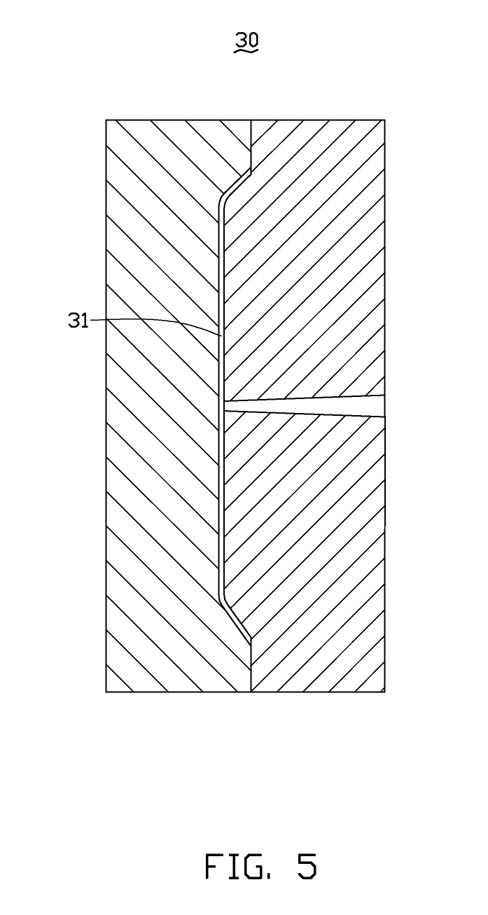

FIG. 6 is a cross-sectional view of the first main body formed in the first injection molding machine.

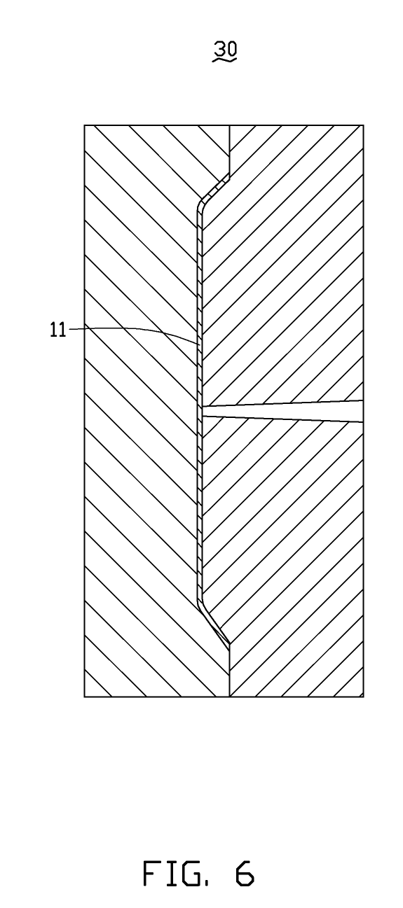

FIG. 7 is a cross-sectional view of a second injection molding machine.

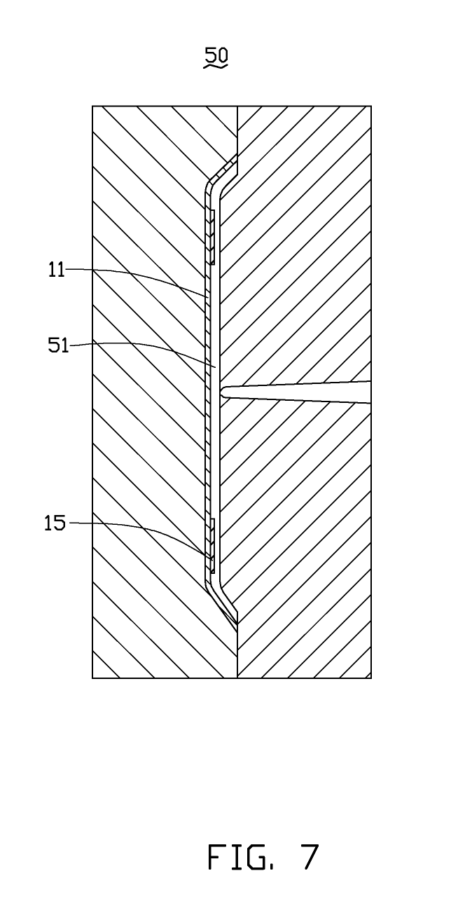

FIG. 8 is a cross-sectional view of the housing formed in the second injection molding machine.

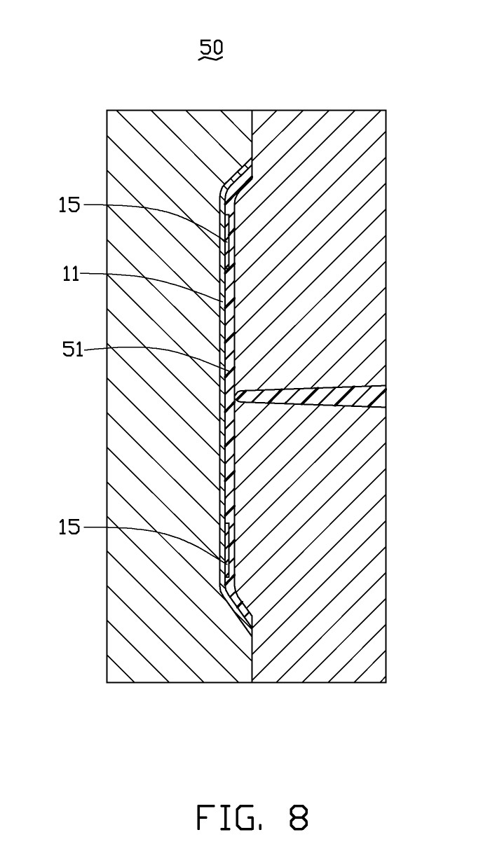

### DETAILED DESCRIPTION

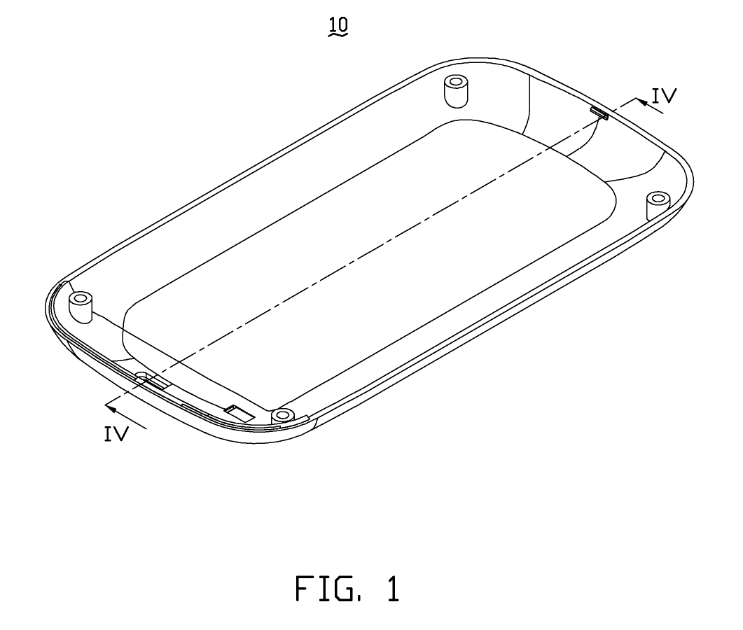

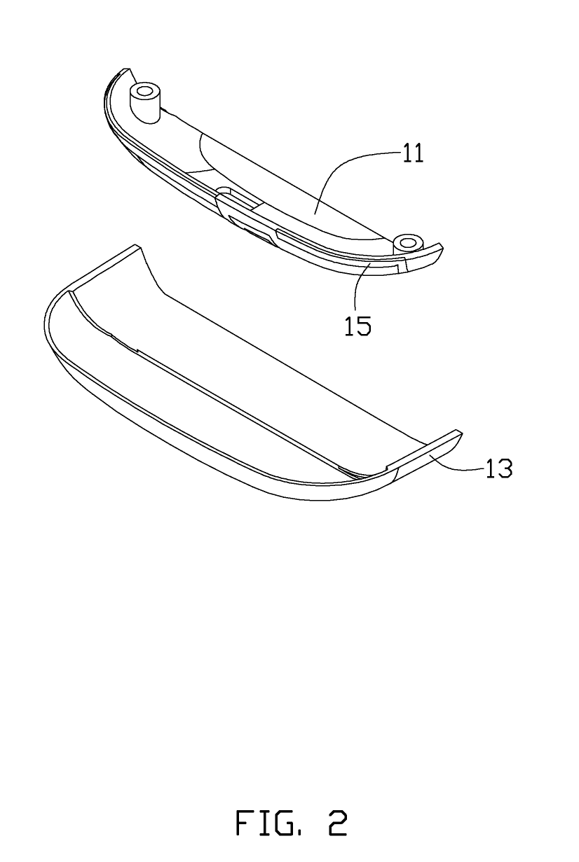

FIG. 1 and FIG. 2 show an exemplary housing 10 used in an electronic device, such as a mobile phone, a personal digital assistant, and so on. The housing 10 includes a first main body 11, a second main body 13, and a three-dimensional antenna 15 sandwiched between the first main body 11 and the second main body 13.

The main body 11 may be made of a moldable plastic. The moldable plastic may be one or more thermoplastic materials selected from a group consisting of polypropylene (PP), polyamide (PA), polycarbonate (PC), polyethylene terephthalate (PET), and polymethyl methacrylate (PMMA).

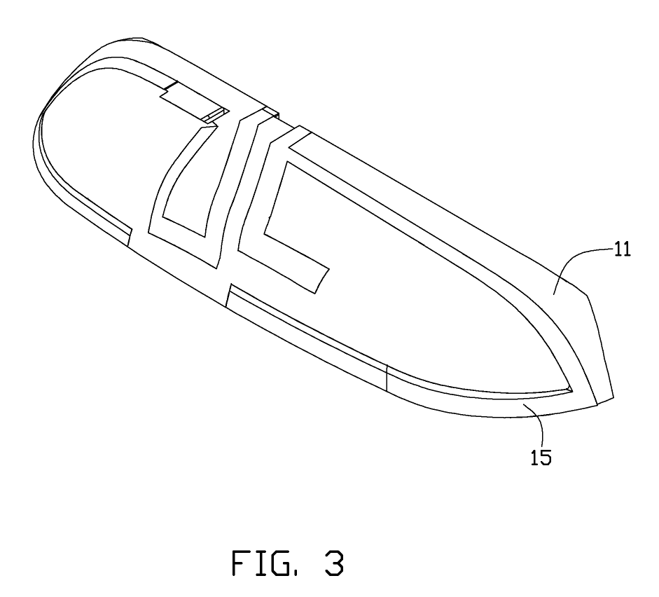

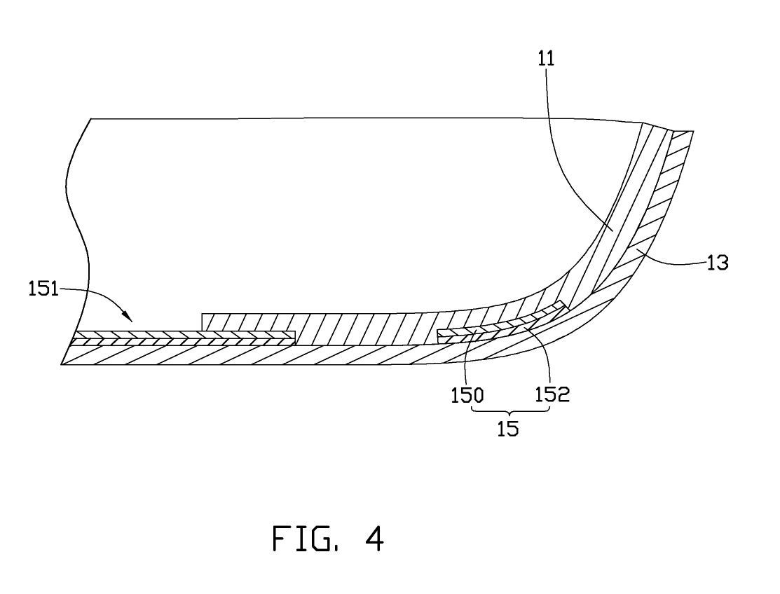

Referring to FIG. 3 and FIG. 4, the three-dimensional antenna 15 includes a printing layer 150 attaching to the housing 10 and a plating layer 152 formed on the printing layer 150. The three-dimensional antenna 15 may have any shape. The printing layer 150 can be made of a material which is capable of having a plating layer formed thereon, such as a copper paste. The printing layer 150 is coated on the first main body 11 by a pad printing method. The printing layer 150 may have a thickness of about 2 μm. To firmly attach the printing layer 150 to the first main body 11, a roughened surface can be formed on the first main body 11 for increasing an adhesive force between the printing layer 150 and the first main body 11. The plating layer 152, according to the exemplary embodiment, includes a copper layer (distinct from the copper paste layer), a nickel layer, and a gold layer (for clarity, each layer is not separately shown in the FIGS) orderly plated on the copper paste of the printing layer 150. The copper layer is configured for transmitting/receiving wireless signals. The nickel layer has antioxidant effects for protecting the copper layer. The gold layer is highly conductive for enhancing transmission and receiving functions of the three-dimensional antenna 15. The multi-layered plating layer 152 may have a total thickness of about 10-12 μm.

The second main body 13 can be attached to the first main body 11 and cover the three-dimensional antenna 15 and can be made by injection molding. The second main body 13 may be made of one or more thermoplastic materials selected from a group consisting of polypropylene, polyamide, polycarbonate, polyethylene terephthalate, and polymethyl methacrylate.

An exemplary embodiment of a method for making the housing 10 may comprise the following steps:

A first injection molding machine 30 and a second injection molding machine 50 are provided. The first injection molding machine 30 includes a first molding chamber 31 and the second injection molding machine 50 includes a second molding chamber 51. The thermoplastic material is injected into the first molding chamber 31 to form the first main body 11. The roughened surface is formed on the first main body 11. The roughened surface can be formed directly during the injection molding, or can be formed on the first main body 11 after injection molding process is completed. The roughened surface has substantially the same shape as the three-dimensional antenna 15.

A pad printing machine is provided. The pad printing machine may include a plurality of silicone pads and a printing plate. The printing plate defines an etched area substantially corresponding to the three-dimensional antenna 15. The etched area is filled with the material capable of having a plating layer formed thereon, such as the copper paste. During printing, the silicone pads of the pad printing machine are pressed down onto the printing plate to transfer the plating material from the etched area onto the silicone pads. The silicone pads are then pressed down onto the roughened surface to form the printing layer 150 on the first main body 11.

The plating layer 152 is formed on the printing layer 150 using a plating process. The plating process may include the following steps: connecting the printing layer 150 to a cathode, and then placing the first main body 11 into a plating solution containing copper ions. An anode connected to a copper post is placed into the plating solution. When power is applied, copper ions attach to material of the printing layer 150 to form a distinct, e.g., copper plating layer. Then a similar method is applied to form the nickel layer and the gold layer in that order on the copper plating layer.

The first main body 11 and the three-dimensional antenna 15 attached to the first main body 11 are placed into the second molding chamber 51. Then, the thermoplastic plastic is injected into the second molding chamber 51 to form the second main body 13 at a side of the first main body 11, partially covering the three-dimensional antenna 15, leaving a terminal 151 exposed from the first main body 11 and the second main body 13.

The three-dimensional antenna 15 is sandwiched between the first main body 11 and the second main body 13, thus the housing 10 can protect the three-dimensional antenna 15 from being damaged. Furthermore, the exemplary three-dimensional antenna 15 is a thin and directly embedded into the housing 10, thus, the three-dimensional antenna 15 takes up less space in the portable electronic device.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A housing, comprising:
a first main body;
a three-dimensional antenna comprising a printing layer attached to the first main body and a plating layer formed on the printing layer, and
a second main body attached to the first main body and partially covering the three-dimensional antenna, the three-dimensional antenna being sandwiched between the first main body and the second main body, and the antenna being partially exposed from the first main body and the second main body to form a terminal.

2. The housing as claimed in claim 1, wherein the plating layer has a thickness of about 10-12 μm.

3. The housing as claimed in claim 2, wherein the printing layer is made of material capable of having a plating layer formed thereon and having a thickness of about 2 μm.

4. The housing as claimed in claim 3, wherein the printing layer is made of copper paste.

5. The housing as claimed in claim 1, wherein the first main body comprises a roughened surface, the three-dimensional antenna is attached to the roughened surface.

6. The housing as claimed in claim 1, wherein the first main body and the second main body are molded with plastics being one or more thermoplastic materials selected from a group consisting of polypropylene, polyamide, polycarbonate, polyethylene terephthalate, and polymethyl methacrylate.

7. A method for making a housing, comprising:
injecting thermoplastic material into a first molding chamber to form a first main body;
forming a printing layer on the first main body;
placing the combination of the first main body and three-dimensional antenna into a second molding chamber;
plating a plating layer on the printing layer to form a three-dimensional antenna; and
injecting the thermoplastic materials into the second molding chamber to form a second main body attached to the first main body and partially covering the three-dimensional antenna.

8. The method for making a housing as claimed in claim 7, wherein a pad printing machine is provided during the pad printing process, the pad printing machine comprises at least one silicone pad and a printing plate; the printing plate filled with the plating material, the silicone pad is pressed down onto the printing plate, then pressed down onto the first main body to form the printing layer.

9. The method for making a housing as claimed in claim 8, wherein the printing layer is made of copper paste.

10. The method for making a housing as claimed in claim 7, wherein the plating layer has a thickness of about 10-12 μm.

11. The method for making a housing as claimed in claim 10, wherein the printing layer is made of material which is capable of having a plating layer formed thereon, the printing layer has a thickness of about 2 μm.

12. The method for making a housing as claimed in claim 7, wherein the first main body comprises a roughened surface, the three-dimensional antenna is attached to the roughened surface.
